(19) United States
(12) Patent Application Publication
(10) Pub. No.: US 2015/0264033 A1
(43) Pub. Date: Sep. 17, 2015

(54) NETWORK APPARATUS AND METHOD FOR ESTABLISHING NETWORK CONNECTION

(71) Applicant: Cameo Communications, Inc., Taipei City (TW)

(72) Inventors: Yen-Ting CHEN, Taipei City (TW); Shin-Fa CHEN, Taipei City (TW)

(21) Appl. No.: 14/314,037

(22) Filed: Jun. 25, 2014

(30) Foreign Application Priority Data
Mar. 11, 2014 (TW) 103108437

(51) Int. Cl. H04L 29/06; H04W 4/00; H04L 29/08

(52) U.S. Cl. CPC H04L 63/083; H04L 67/141; H04W 4/008; H04L 63/0407

(57) ABSTRACT

A network apparatus includes a first connection module, a data management module and an encoder. The data management module is electrically connected with the first connection module. The data management module is configured for storing at least one connection data. The encoder is electrically connected with the data management module. The encoder is configured for translating the connection data into a connection instruction, and for translating the connection instruction into a code which is configured to be translated by a decoder of an electronic apparatus into the connection instruction, and thus a second connection module of the electronic apparatus is connected to the first connection module according to the connection instruction. Consequently, a network connection is established between the first connection module and the second connection module.

### RELATED APPLICATIONS

This application claims priority to Taiwanese Application Serial Number 103108437, filed Mar. 11, 2014, the entirety of which is herein incorporated by reference.

### BACKGROUND

1. Technical Field

The present disclosure relates to a network apparatus. More particularly, the present disclosure relates to a network apparatus and a method for establishing network connection quickly and easily.

2. Description of Related Art

As the development of network technology, network apparatuses like wireless routers are getting more and more popular. The network apparatuses are widely used in household applications, and also in public spaces, such as coffee shops, restaurants, railway stations and companies. However, when a user would like to establish a network connection between an electronic apparatus and a network apparatus, particularly for the network apparatus being located in a public space and no network connection ever established between the network apparatus and the electronic apparatus, the user usually needs to perform steps and enter information required to establish the network connection on the electronic apparatus.

For example, when the user wants to establish the network connection between a mobile device and a wireless router in a public space so as for the mobile device to utilize the network service provided by the wireless router, the user has to inquire the service set identifier (SSID), the user account and the user password of the wireless router. The user has to search for the wireless router according to the service set identifier by utilizing a network connection setup page of the mobile device. Subsequently, it is required for the user to enter the user account and the user password to establish the network connection between the mobile device and the wireless router. As such, the network service provided by the wireless router becomes accessible for the user.

### SUMMARY

In one aspect, the present disclosure is related to a network apparatus including a first connection module, a data management module and an encoder. The data management module is electrically connected with the first connection module. The data management module is configured for storing at least one connection data. The encoder is electrically connected with the data management module. The encoder is configured for translating the connection data into a connection instruction, and for translating the connection instruction into a code which is configured to be translated by a decoder of an electronic apparatus into the connection instruction, such that a second connection module of the electronic apparatus is connected to the first connection module according to the connection instruction. Consequently, a network connection is established between the first connection module and the second connection module.

In another aspect, the present disclosure is related to a method for establishing network connection including the following steps: storing connection data; translating the connection data into a connection instruction; translating the connection instruction into a code; and decoding the code into the connection instruction, and establishing a network connection between an electronic apparatus and a network apparatus according to the connection instruction.

By applying the techniques disclosed in the present disclosure, the user can easily and quickly establish the network connection between the electronic apparatus and the network apparatus by simply utilizing the electronic apparatus to read the abovementioned code translated from the connection instruction. Consequently, the user neither needs to search for the network apparatus by utilizing the electronic apparatus nor needs to enter the account or password data on the electronic apparatus. Therefore, the steps and time required for establishing the network connection can be reduced.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a network apparatus in accordance with one embodiment of the present disclosure;

FIG. 2 is a block diagram of a network apparatus in accordance with one embodiment of the present disclosure;

FIG. 3 is a block diagram of a network apparatus in accordance with one embodiment of the present disclosure;

FIG. 4 is a flow chart of a method for establishing network connection in accordance with one embodiment of the present disclosure;

FIG. 5 is a flow chart of a method for establishing network connection in accordance with one embodiment of the present disclosure;

FIG. 6 is a flow chart of a method for establishing network connection in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

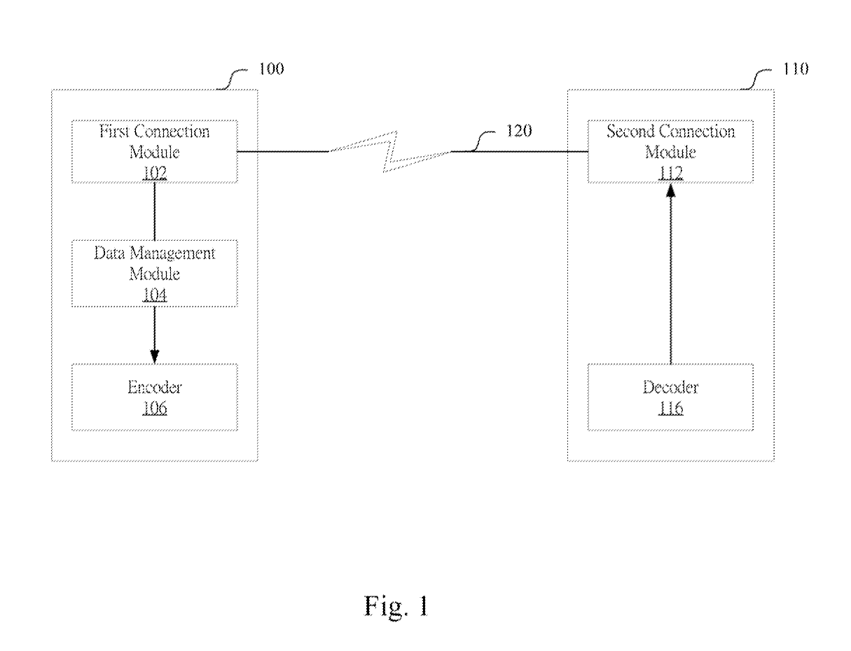

Reference is made first to FIG. 1. FIG. 1 is a block diagram of a network apparatus 100 in accordance with one embodiment of the present disclosure. The network apparatus 100 can be a wireless router, a wireless repeater or a network switch. In an example, the network apparatus 100 is a wireless router which is configured for providing network connection for the electronic apparatus 110 so that the electronic apparatus 110 can access the Internet. The electronic apparatus 110 can be a smart phone, a tablet computer, a laptop or a wearable electronic device (for example, smart glasses).

Conventionally, when a user would like to establish a network connection 120 between the electronic apparatus 110 and the network apparatus 100 (especially when the network connection 120 is a wireless network connection), and utilize the network service provided by the network apparatus 100 (for example, the connection to the Internet), the user has to inquire the service set identifier (SSID), the user account and the user password of the network apparatus 100. Then the user has to search for the network apparatus 100 according to the service set identifier by utilizing a network connection setup page of the electronic apparatus 110. Subsequently, the user has to enter the user account and the user password so that the network connection 120 can be established and the network service provided by the network apparatus 100 can be utilized. The abovementioned conventional procedures for establishing network connections are not convenient for most users.

In the present embodiment, the network apparatus 100 includes a first connection module 102, a data management module 104 and an encoder 106.

In an embodiment of the present disclosure, the first connection module 102 is a wireless fidelity (WiFi) connection module. In another embodiment, the network apparatus 100 includes memory and one or more processors. The data management module 104 and the encoder 106 are stored in the memory and configured for execution by the one or more processors. The data management module 104 is electrically connected with the first connection module 102. The data management module 104 is configured for storing connection data. In still another embodiment, the data management module 104 is further configured for modifying the connection data according to a connection data modification command (not depicted). The connection data modification command can be a command from the user.

The encoder 106 is electrically connected with the data management module 104. The encoder 106 is configured for translating the connection data into a connection instruction, and for translating the connection instruction into a code. A decoder 116 of the electronic apparatus 110 translates the code into the connection instruction. A second connection module 112 of the electronic apparatus 110 connects to the first connection module 102 according to the connection instruction so that the network connection 120 is established between the first connection module 102 and the second connection module 112. In an embodiment of the present disclosure, the electronic apparatus 110 includes memory and one or more processors. The decoder 116 is stored in the memory and configured for execution by the one or more processors.

In an embodiment of the present disclosure, the network apparatus 100 is a wireless router and the electronic apparatus 110 is a smart phone. The connection data includes service set identifier data corresponding to the network apparatus 100, network connection encryption mode data, account data and password data. The connection instruction includes a string which includes the abovementioned service set identifier data corresponding to the network apparatus 100, the abovementioned network connection encryption mode data, the abovementioned account data and the abovementioned password data. The encoder 106 is configured for translating the connection instruction into a code according to an encoding rule. The decoder 116 translates the code into the connection instruction according to a decoding rule corresponding to the abovementioned encoding rule. The second connection module 112 searches for the network apparatus 100 according to the service set identifier data corresponding to the network apparatus 100, and transmits the abovementioned account data and the abovementioned password data to the first connection module 102. The data management module 104 is further configured for comparing the abovementioned account data and the abovementioned password data with the content of the connection data. The first connection module 102 provides network services for the second connection module 112 according to a result of comparison.

In an embodiment of the present disclosure, the encoder 106 is further configured for translating the abovementioned connection instruction into an encrypted connection instruction by utilizing an encryption algorithm, and for translating the encrypted connection instruction into the abovementioned code. The decoder 116 further decodes the abovementioned code into the abovementioned encrypted connection instruction, and translates the abovementioned encrypted connection instruction into the abovementioned connection instruction by utilizing a decryption algorithm corresponding to the abovementioned encryption algorithm. The abovementioned encryption algorithm can be a RSA encryption algorithm.

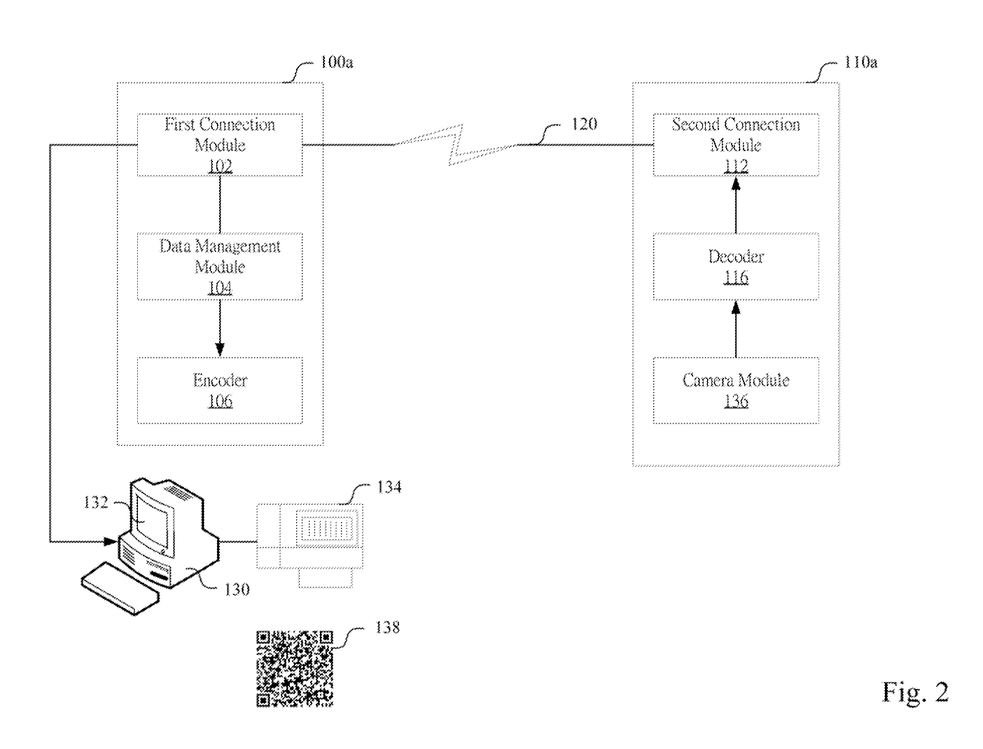

Reference is made also to FIG. 2. FIG. 2 is a block diagram of a network apparatus 100a in accordance with one embodiment of the present disclosure. In this embodiment, the abovementioned code can be a quick response code (QR code), and the first connection module 102 is further configured for transmitting the abovementioned code (i.e., the QR code) to a computer device 130. The computer device 130 can be a desktop computer, a laptop, a tablet computer or a smart phone. The computer device 130 includes a display monitor 132 and a printer 134. The computer device 130 outputs the QR code 138 by utilizing the display monitor 132 or the printer 134. The electronic apparatus 110a further includes a camera module 136. The camera module 136 is configured for reading the QR code 138, and for transmitting the QR code 138 to the decoder 116.

In the present embodiment, the user can easily and quickly establish the network connection 120 between the electronic apparatus 110a and the network apparatus 100a by simply utilizing the camera module 136 of the electronic apparatus 110a to read the QR code 138. Consequently, the user neither needs to search for the network apparatus 100a by utilizing the electronic apparatus 110a nor needs to enter the account or password data on the electronic apparatus 110a. Therefore, the steps and time required for establishing the network connection 120 can be reduced.

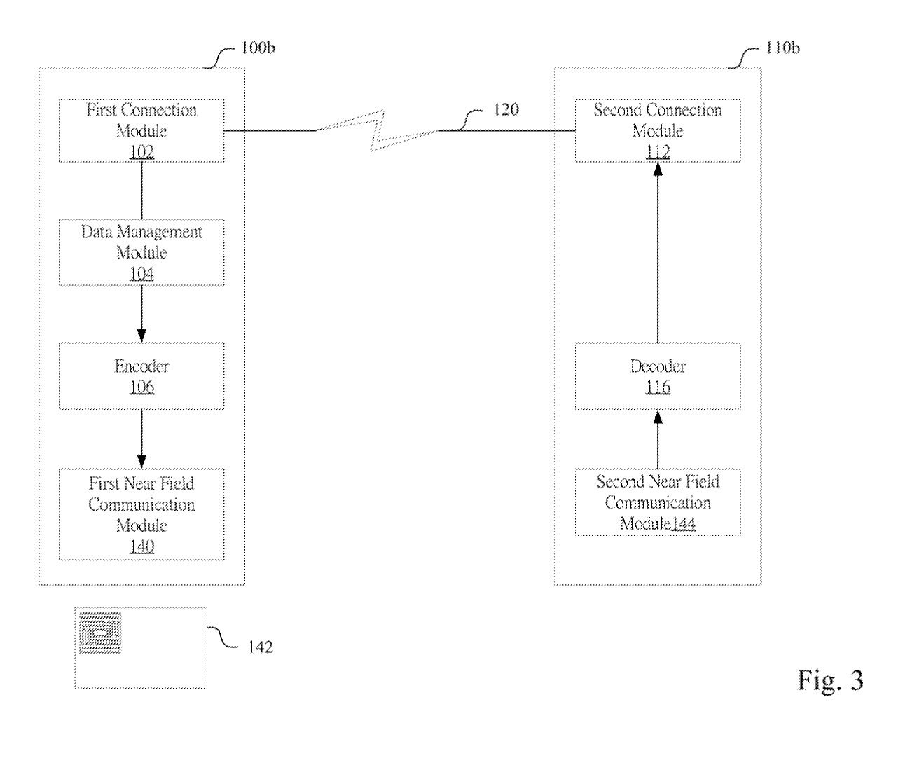

Additional reference is made to FIG. 3. FIG. 3 is a block diagram of a network apparatus 100b in accordance with one embodiment of the present disclosure. In this embodiment, the network apparatus 100b further includes a first near field communication (NFC) module 140. The electronic apparatus 110b further includes a second near field communication module 144. The first near field communication module 140 is electrically connected with the encoder 106. The first near field communication module 140 is configured for storing the abovementioned code in a radio frequency identification (RFID) tag 142, or for transmitting the abovementioned code to the second near field communication module 144 of the electronic apparatus 110b. The second near field communication module 144 then transmits the received code to the decoder 116.

In an example, the network apparatus 100b is a wireless router, and the electronic apparatus 110b is a smart phone. The user moves the RFID tag 142 to a place near the smart phone when he/she would like to establish the network connection 120. The second near field communication module 144 of the smart phone reads the abovementioned code stored in the RFID tag 142, and transmits the abovementioned code to the decoder 116.

In this example, by moving the RFID tag 142 storing the abovementioned code to a place near the smart phone which supports near field communication technique, the smart phone can read the abovementioned code. Consequently, the network connection between the smart phone and the wireless router can be established easily and quickly.

In another example, the network apparatus 100b is a wireless router, and the electronic apparatus 110b is a tablet computer. The user moves the tablet computer to a place near the wireless router when he/she would like to establish the network connection 120. Then the first near field communication module 140 transmits the abovementioned code to the second near field communication module 144.

In this example, by moving the tablet computer which supports near field communication technique to a place near the wireless router, the wireless router can transmit the abovementioned code to the tablet computer. Consequently, the network connection between the tablet computer and the wireless router can be established easily and quickly.

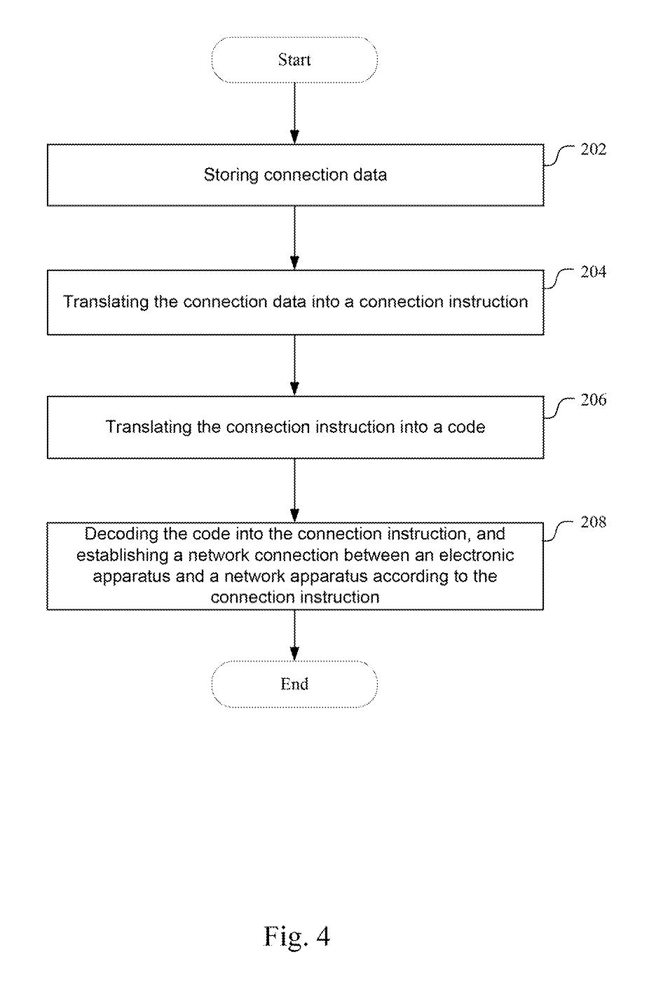

Reference is now made to FIG. 4. FIG. 4 is a flow chart of a method for establishing network connection in accordance with one embodiment of the present disclosure. The method for establishing network connection may be implemented by the network apparatus 100 illustrated in FIG. 1, but is not limited in this regard. For convenience and clarity, it is assumed that the method for establishing network connection is implemented by the network apparatus 100 illustrated in FIG. 1.

In step 202, the data management module 104 stores connection data. Then in step 204, the encoder 106 translates the connection data into a connection instruction. In step 206, the encoder 106 translates the connection instruction into a code. Subsequently, in step 208 the decoder 116 decodes the code into the connection instruction, and establishes the network connection 120 between the electronic apparatus 110 and the network apparatus 100 according to the connection instruction.

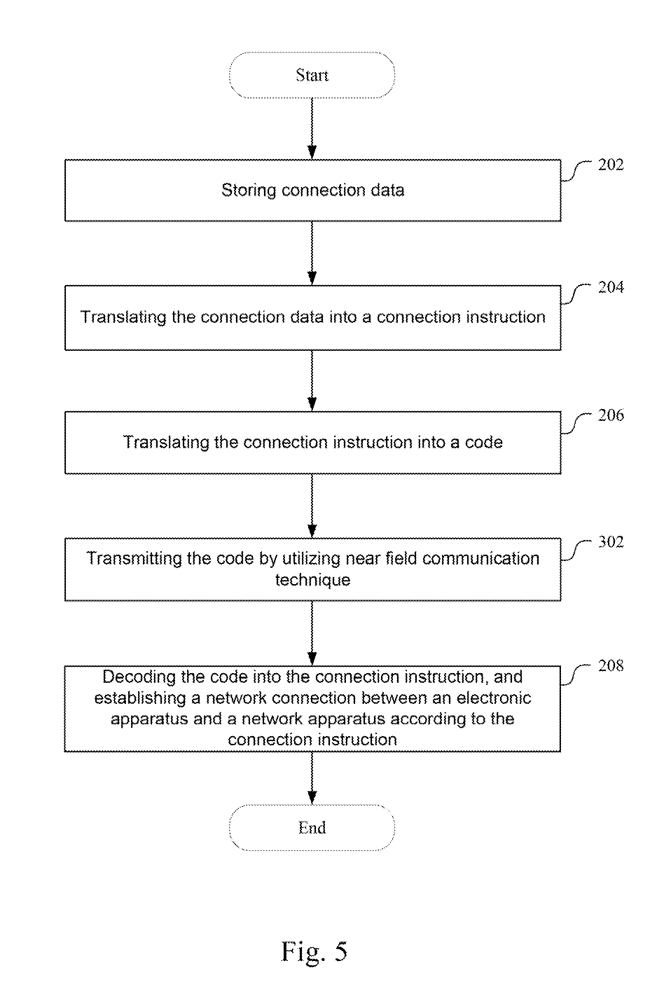

Reference is made also to FIG. 5. FIG. 5 is a flow chart of a method for establishing network connection in accordance with one embodiment of the present disclosure. Compared with the method for establishing network connection illustrated in FIG. 4, the method for establishing network connection illustrated in FIG. 5 further includes step 302. The method for establishing network connection may be implemented by the network apparatus 100b illustrated in FIG. 3, but is not limited in this regard. For convenience and clarity, it is assumed that the method for establishing network connection is implemented by the network apparatus 100b illustrated in FIG. 3.

In step 302, the first near field communication module 140 transmits the abovementioned code to the second near field communication module 144 by utilizing near field communication technique.

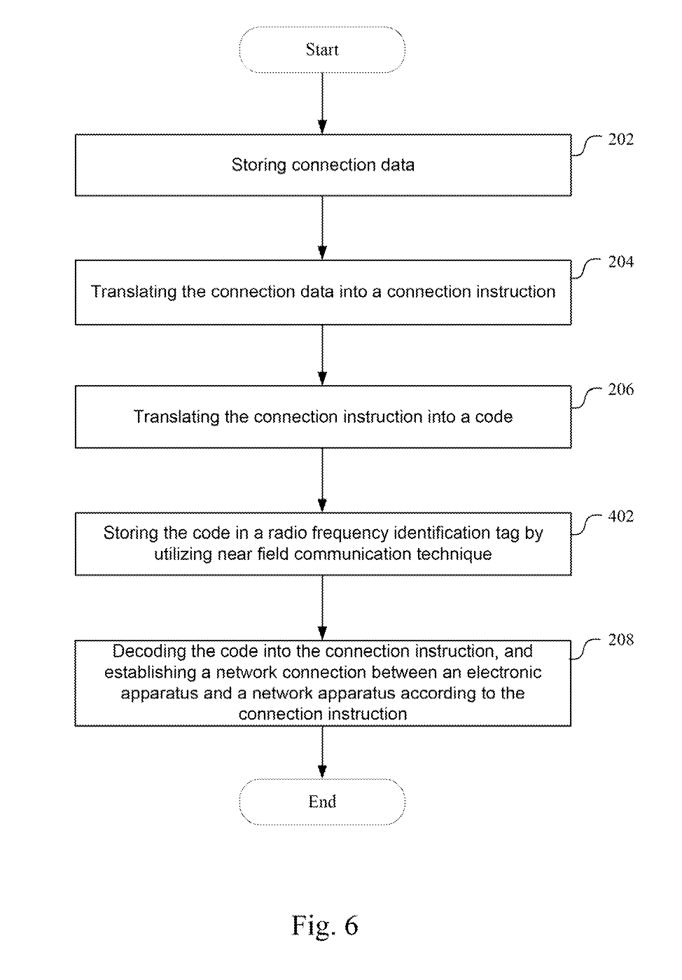

Reference is now made to FIG. 6. FIG. 6 is a flow chart of a method for establishing network connection in accordance with one embodiment of the present disclosure. Compared with the method for establishing network connection illustrated in FIG. 4, the method for establishing network connection illustrated in FIG. 6 further includes step 402. The method for establishing network connection may be implemented by the network apparatus 100b illustrated in FIG. 3, but is not limited in this regard. For convenience and clarity, it is assumed that the method for establishing network connection is implemented by the network apparatus 100b illustrated in FIG. 3.

In step 402, the first near field communication module 140 stores the abovementioned code in the radio frequency identification tag 142 by utilizing near field communication technique.

The above illustrations include exemplary operations, but the operations are not necessarily performed in the order shown. Operations may be added, replaced, changed order, and/or eliminated as appropriate, in accordance with the spirit and scope of various embodiments of the present disclosure.

According to the above embodiments, the user can easily and quickly establishes the network connection between the electronic apparatus and the network apparatus by simply utilizing the electronic apparatus to read the abovementioned code translated from the connection instruction. Consequently, the user neither needs to search for the network apparatus by utilizing the electronic apparatus nor needs to enter the account or password data on the electronic apparatus. Therefore, the steps and time required for establishing the network connection can be reduced.

For example, when the abovementioned code is a QR code, the user can easily and quickly establish the network connection between the electronic apparatus and the network apparatus by simply utilizing the camera module of the electronic apparatus to read the OR code.

In another example, the user can move the RFID tag storing the abovementioned code to a place near the electronic apparatus which supports near field communication technique so that the electronic apparatus can read the abovementioned code, and the network connection between the electronic apparatus and the network apparatus can be established easily and quickly.

In still another example, the user can move the electronic apparatus which supports near field communication technique to a place near the network apparatus so that the network apparatus can transmit the abovementioned code to the electronic apparatus. Consequently, the network connection between the electronic apparatus and the network apparatus can be established easily and quickly.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A network apparatus comprising:
a first connection module;
a data management module, electrically connected with the first connection module, the data management module being configured for storing connection data; and
an encoder, electrically connected with the data management module, the encoder being configured for translating the connection data into a connection instruction and for translating the connection instruction into a code which is configured to be translated by a decoder of an electronic apparatus into the connection instruction, such that a second connection module of the electronic apparatus is connected to the first connection module according to the connection instruction, and a network connection is established between the first connection module and the second connection module.

2. The network apparatus of claim 1, wherein the first connection module is configured for transmitting the code to a computer device to output the code.

3. The network apparatus of claim 1, wherein the code is a quick response code (QR code).

4. The network apparatus of claim 3, wherein the electronic apparatus further comprises a camera module, and the camera module is configured for reading the quick response code, and for transmitting the quick response code to the decoder.

5. The network apparatus of claim 1, further comprising a first near field communication (NFC) module, electrically connected with the encoder, the first near field communication module being configured for storing the code in a radio frequency identification (RFID) tag or for transmitting the code to a second near field communication module of the electronic apparatus, the second near field communication module being configured for transmitting the received code to the decoder.

6. The network apparatus of claim 1, wherein the connection data comprises service set identifier (SSID) data, network connection encryption mode data, account data and password data.

7. The network apparatus of claim 6, wherein the connection instruction comprises a string which comprises the service set identifier data, the network connection encryption mode data, the account data and the password data; the second connection module is configured for searching for the network apparatus according to the service set identifier data, and transmitting the account data and the password data to the first connection module; the data management module is further configured for comparing the account data and the password data with the content of the connection data; and the first connection module is configured for providing network services for the second connection module according to a result of comparison.

8. The network apparatus of claim 1, wherein the encoder is further configured for translating the connection instruction into an encrypted connection instruction by utilizing an encryption algorithm, and for translating the encrypted connection instruction into the code; and the decoder is further configured for decoding the code into the encrypted connection instruction, and translating the encrypted connection instruction into the connection instruction by utilizing a decryption algorithm corresponding to the encryption algorithm.

9. The network apparatus of claim 1, wherein the data management module is further configured for modifying the connection data according to a connection data modification command.

10. A method for establishing network connection comprising:
storing connection data;
translating the connection data into a connection instruction;
translating the connection instruction into a code; and
decoding the code into the connection instruction, and establishing a network connection between an electronic apparatus and a network apparatus according to the connection instruction.

11. The method of claim 10, wherein the code is a quick response code.

12. The method of claim 10 further comprising:
transmitting the code by utilizing near field communication technique.

13. The method of claim 10 further comprising:
storing the code in a radio frequency identification tag by utilizing near field communication technique.

14. The method of claim 10, wherein the connection data comprises service set identifier data, network connection encryption mode data, account data and password data.
